(19) United States
(12) Patent Application Publication
(10) Pub. No.: US 2010/0186068 A1
(43) Pub. Date: Jul. 22, 2010

(54) COMMUNICATION APPARATUS, COMMUNICATION CONTROL METHOD, AND PROGRAM

(76) Inventor: Yoshiki Okuyama, Tokyo (JP)

Correspondence Address: Mr. Jackson Chen, 6535 N. STATE HWY 161, IRVING, TX, 75039, US

(21) Appl. No.: 12/602,543

(22) PCT Filed: May 16, 2008
(86) PCT No.: PCT/JP2008/059052

§ 371 Date: Dec. 1, 2009

(30) Foreign Application Priority Data
Jun. 12, 2007 (JP) 2007-155771

(51) Int. Cl. G06F 17/30

(52) U.S. Cl. 726/4

(57) ABSTRACT

When a process (51A) is to execute new data reception, an operation determination unit (54) determines whether to permit data reception by the process by comparing a communication corresponding network ID representing a communication network to be used for data communication by the process with a process corresponding network ID acquired by a process management unit (53).

### TECHNICAL FIELD

The present invention relates to a technique of controlling a communication apparatus and, more particularly, to a security technology for a communication apparatus capable of data communication with a plurality of communication networks.

### BACKGROUND ART

As network connection using various kinds of communication apparatuses such as a portable terminal, PDA, and personal computer is widespread, it becomes common practice for a user to download an application for a portable terminal via a network and execute it. Accordingly, a problem arises when a malicious application executes communication unexpected by the user and causes information outflow (information leakage).

On the other hand, many future portable terminals are expected to be connected to a plurality of network environments such as VPN connection and wireless LAN connection, or a carrier network and a home network. In this case, a malicious application serving as an application gateway can cause data outflow, or allows a network to use data that is exclusively distributed in another certain network.

As a measure against information outflow by a malicious application, file encryption is generally performed. To prevent outflow by file encryption, each file is encrypted by setting a key so that only a user who knows the key can access the file contents.

Conventionally, a technique has been proposed, which automatically encrypts the contents in a storage unit in accordance with a preset encryption key when a portable terminal is disconnected from a corporate LAN (e.g., Japanese Patent Laid-Open No. 10-161935). According to this technique, when the portable terminal is connected to the corporate LAN, the contents in, the storage unit are decrypted using the same encryption key as in encryption so that the user can access the contents. However, encryption of the storage unit or transmission data cannot prevent decryption of encrypted data by a brute force attack or outflow (leakage) of a private key.

To the contrary, in the application execution environment of a portable phone represented by Java®, a list of connectable networks is downloaded as a policy file upon downloading an application. At the time of network connection, the terminal refers to the list and limits access to a network that is not included in the list, thereby preventing data outflow or limiting networks to be used by the application.

### DISCLOSURE OF INVENTION

### Problems to be Solved by the Invention

However, this related technique has a problem in the ease and reliability of information outflow prevention.

More specifically, according to the related technique, to limit accessible networks using a policy file or the like, it is necessary to grasp all accessible networks in advance and describe them in the policy file. To do this, the application creator or network administrator need to grasp the list of connectable networks in advance. If accessible networks change between users, the policy file management becomes more complex.

Even when all accessible networks are described in the policy file, data transfer between the accessible networks is permitted. This is because all data obtained at the time of network access are managed in the same memory space or storage unit even when they are located on different networks. It is therefore impossible to prevent any information outflow to another network that has occurred due to, e.g., a bug in an application.

The present invention has been made to solve the above problem, and has as its exemplary object to provide a communication apparatus, communication control method, and program which ensure easy and reliable information outflow prevention.

### Means of Solution to the Problems

In order to achieve the above exemplary object, according to an exemplary aspect of the present invention, there is provided a communication apparatus including a communication processing unit which executes data communication via one of a plurality of connectable communication networks, an application processing unit which executes a desired application process by controlling the communication processing unit and activating a process of executing data communication for at least one of data reception and data transmission, a storage unit which stores a process management table to register a set of process identification information unique to the process and network identification information unique to a communication network made to correspond to the process in advance, a process management unit which acquires network identification information corresponding to the process identification information of the process from the process management table, and an operation determination unit which, in performing new data communication by the process, compares communication corresponding network identification information representing a communication network to be used for data communication by the process with process corresponding network identification information which is the network identification information of the process acquired by the process management unit, thereby determining whether to permit the new data communication by the process.

According to another exemplary aspect of the present invention, there is also provided a communication apparatus including a communication processing unit which executes data communication via one of a plurality of connectable communication networks, an application processing unit which executes a desired application process by controlling the communication processing unit and activating a process of executing data communication for at least one of data reception and data transmission, a storage unit which stores a file that describes arbitrary data, and a file management table to register a set of file identification information unique to the file and network identification information unique to a communication network made to correspond to the file, a file management unit which, on the basis of an instruction from the process, executes file access to the storage unit to at least read out or write the file, and acquires, from the file management table, network identification information corresponding to the file identification information of the file to be file-accessed by the process, and an operation determination unit which determines, when the process is to execute new file access to the storage unit, whether to permit the new file access by the process in accordance with a result of comparison between process corresponding network identification information which is network identification information representing a communication network to be used for data communication by the process and file corresponding network identification information which is network identification information of the file acquired by the file management unit.

According to another exemplary aspect of the present invention, there is also provided a communication control method of a communication apparatus which includes an arithmetic processing unit and a storage unit and executes data communication via one of a plurality of connectable communication networks, including the communication processing step of causing the arithmetic processing unit to execute data communication via one of a plurality of connectable communication networks, the application processing step of causing the arithmetic processing unit to execute a desired application process by controlling the communication processing step and activating a process of executing data communication for at least one of data reception and data transmission, the storage step of causing the storage unit to store a process management table to register a set of process identification information unique to the process and network identification information unique to a communication network made to correspond to the process in advance, the process management step of causing the arithmetic processing unit to acquire network identification information corresponding to the process identification information of the process from the process management table, and the operation determination step of, in performing new data communication by the process, causing the arithmetic processing unit to compare communication corresponding network identification information representing a communication network to be used for data communication by the process with process corresponding network identification information which is the network identification information of the process acquired in the process management step, thereby determining whether to permit the new data communication by the process.

According of another exemplary aspect of the present invention, there is also provided a communication control method of a communication apparatus which includes an arithmetic processing unit and a storage unit and executes data communication via one of a plurality of connectable communication networks, including the communication processing step of causing the arithmetic processing unit to execute data communication via one of a plurality of connectable communication networks, the application processing step of causing the arithmetic processing unit to execute a desired application process by controlling the communication processing step and activating a process of executing data communication for at least one of data reception and data transmission, the storage step of causing the storage unit to store a file that describes arbitrary data, and a file management table to register a set of file identification information unique to the file and network identification information unique to a communication network made to correspond to the file, the file management step of causing the arithmetic processing unit to execute, on the basis of an instruction from the process, file access to the storage unit to at least read out or write the file, and acquire, from the file management table, network identification information corresponding to the file identification information of the file to be file-accessed by the process, and the operation determination step of, when the process is to execute new file access to the storage unit, determining whether to permit the new file access by the process in accordance with a result of comparison between the process corresponding network identification information corresponding to the process and file corresponding network identification information which is network identification information of the file acquired in the file management step.

According to another exemplary aspect of the present invention, there is provided a program for causing a computer of a communication apparatus which includes an arithmetic processing unit and a storage unit and executes data communication via one of a plurality of connectable communication networks to execute the above-described communication control method.

### EFFECTS OF THE INVENTION

According to the exemplary aspects of the present invention, if a communication network already made to correspond to a process is different from a new communication network to be used for data communication by the process, the process is inhibited from executing the data communication using the new communication network. Only when no communication network is made to correspond to the process, or the new communication network matches the communication network made to correspond to the process, the process is permitted to execute the data communication using the communication network. This allows to limit networks to be used by an application and prevent data transfer, i.e., information outflow to another network.

To limit accessible networks using a policy file or the like, it is necessary to grasp all accessible networks in advance and describe them in the policy file. According to the exemplary aspects of the present invention, however, no policy file is necessary because whether to permit data communication is determined based on a set of a process ID and a network ID. Neither the application creator nor the network administrator need grasp the list of connectable networks in advance. It is therefore possible to suppress any increase in work load for policy file management and ensure easy and reliable information outflow prevention in data reception.

### BRIEF DESCRIPTION OF DRAWINGS

FIG. 1 is a block diagram showing the arrangement of a communication apparatus according to the first exemplary embodiment of the present invention;

FIG. 2 is a view showing an example of the arrangement of a process management table;

FIG. 3 is a sequence chart showing the data reception operation of the communication apparatus according to the first exemplary embodiment of the present invention;

FIG. 4 is a sequence chart showing the data transmission operation of the communication apparatus according to the first exemplary embodiment of the present invention;

FIG. 5 is a block diagram showing the arrangement of a communication apparatus according to the second exemplary embodiment of the present invention;

FIG. 6 is a view showing an example of the arrangement of a file management table;

FIG. 7 is a sequence chart showing the file readout operation of the communication apparatus according to the second exemplary embodiment of the present invention;

FIG. 8 is a sequence chart showing the file write operation of the communication apparatus according to the second exemplary embodiment of the present invention; and

FIG. 9 is a sequence chart showing the file update operation of the communication apparatus according to the second exemplary embodiment of the present invention.

### DESCRIPTION OF THE PREFERRED EXEMPLARY EMBODIMENTS

The exemplary embodiments of the present invention will now be described with reference to the accompanying drawings.

### First Exemplary Embodiment

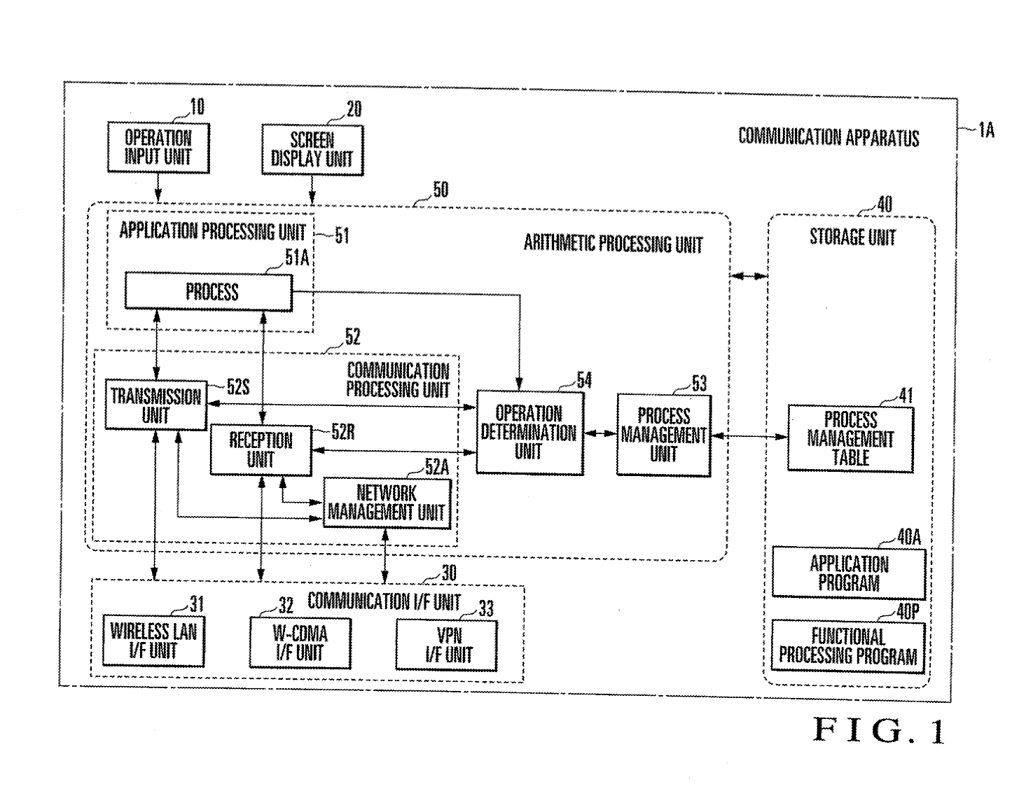

A communication apparatus according to the first exemplary embodiment of the present invention will be described first with reference to FIG. 1. FIG. 1 shows the arrangement of the communication apparatus according to the first exemplary embodiment of the present invention.

A communication apparatus 1A is formed from an information processing apparatus having a computer, such as a portable terminal, PDA, personal computer, or server apparatus. The communication apparatus 1A has a function of executing data communication via one of a plurality of connectable communication networks by executing an application program. The communication networks here are assumed to be various kinds of data communication networks such as the Internet, LAN, wireless LAN, VPN, W-CDMA, and portable phone network to be used for various kinds of data communication.

The communication apparatus 1A includes, as main functional units, an operation input unit 10, screen display unit 20, communication I/F unit 30, storage unit 40, and arithmetic processing unit 50. The arithmetic processing unit 50 includes, as main processing units, an application processing unit 51, communication processing unit 52, process management unit 53, and operation determination unit 54.

In this exemplary embodiment, the communication apparatus includes the communication processing unit 52 which executes data communication via one of a plurality of connectable communication networks, the application processing unit 51 which executes a desired application process by controlling the communication processing unit 52 and activating a process of executing data communication for at least one of data reception and data transmission, the storage unit 40 which stores a process management table to register a set of a process ID (process identification information) unique to the process and a network ID (network identification information) unique to a communication network made to correspond to the process in advance, and the process management unit 53 which acquires a network ID corresponding to the process ID of the process from the process management table. When executing new data communication by a process, the operation determination unit 54 compares a communication corresponding network ID representing a communication network to be used for data communication by the process with a process corresponding network ID which is the network ID of the process acquired by the process management unit 53, thereby determining whether to permit the new data communication by the process.

The arrangement of the communication apparatus according to the first exemplary embodiment of the present invention will be described next in detail with reference to FIG. 1.

The operation input unit 10 is formed from, e.g., an operation input device such as a keyboard or pointing device and has a function of detecting a user operation and inputting it to the arithmetic processing unit 50.

The screen display unit 20 is formed from, e.g., a screen display device such as an LCD or PDP and has a function of displaying various kinds of information such as an operation menu, text information, and image information on the screen in accordance with an instruction from the arithmetic processing unit 50.

The communication interface I/F unit (to be referred to as a communication I/F unit hereinafter) 30 includes dedicated communication interface circuits provided for a plurality of different communication networks and has a function of executing data communication with one of the communication networks in accordance with an instruction from the arithmetic processing unit 50.

In the example shown in FIG. 1, the communication I/F unit 30 includes a wireless LAN interface unit (to be referred to as a wireless LAN I/F unit hereinafter) 31 to be used for data communication with a wireless LAN, a W-CDMA interface unit (to be referred to as a W-CDMA I/F unit hereinafter) 32 to be used for data communication with a W-CDMA, and a VPN interface unit (to be referred to as a VPN I/F unit hereinafter) 33 to be used for data communication with a VPN.

The wireless LAN I/F unit 31 can identify a connected network based on communication attribute information such as ESSID or BSSID. The W-CDMA I/F unit 32 can identify a connected carrier based on communication attribute information of SIM. The VPN I/F unit 33 can identify a connected network based on the IP address or set information of a VPN server.

The storage unit 40 is formed from, e.g., a storage device such as a memory or hard disk and has a function of storing various kinds of process information and programs to be used for various kinds of processing operations of the arithmetic processing unit 50.

The main programs stored in the storage unit 40 are a functional processing program 40P and an application program 40A. These programs are stored in a ROM at the time of manufacture to form the storage unit 40, or loaded from an external device to the storage unit 40 via the communication I/F unit 30.

When the communication apparatus 1A is activated, the functional processing program 40P is read out and executed by the arithmetic processing unit 50, thereby implementing a processing unit for executing various kinds of processing operations of the arithmetic processing unit 50.

The application program 40A is read out and executed by the arithmetic processing unit 50 in accordance with a user operation and executes an information calculation process or data communication using various kinds of functional units provided in the communication apparatus 1A or various kinds of processing units implemented by the functional processing program 40P, thereby providing a predetermined information processing function or data communication function to the user.

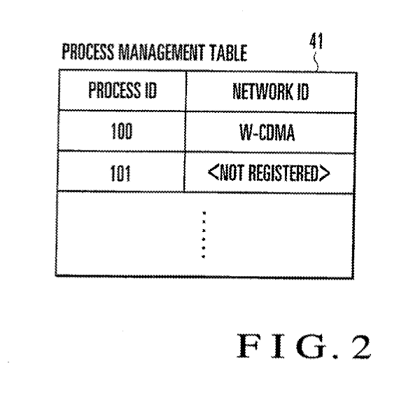

Main process information stored in the storage unit 40 is a process management table 41. FIG. 2 shows an example of the arrangement of the process management table. The process management table 41 has a function of storing a set of a process ID which is unique to each process 51A and is used to identify the process and a network ID which is unique to a communication network to be used for data communication by the process 51A and is used to identify the communication network.

The process 51A is a small-scale processing unit which is activated and implemented as an instance when the application processing unit 51 (to be described later) executes the application program 40A.

The process management table 41 may manage the set for each process 51A as known process structure data. The process structure data includes management data groups collected for the respective processes to manage them. A general operating system (arithmetic processing unit 50) generates process structure data based on a predetermined data structure at the time of activating a process and stores it in a table (process management table 41). At the end of a process, corresponding process structure data is deleted from the table.

The arithmetic processing unit 50 has a microprocessor such as a CPU and peripheral circuits. The arithmetic processing unit 50 has a function of reading out the functional processing program 40P from the storage unit 40 and executing it in cooperation with the above-described hardware, thereby implementing processing units for executing various kinds of process operations and the operating system as the base of these units.

The main processing units to be implemented by the arithmetic processing unit 50 are the application processing unit 51, communication processing unit 52, process management unit 53, and operation determination unit 54.

The application processing unit 51 has a function of reading out the application program 40A from the storage unit 40 and executing it to activate the process 51A, thereby executing a desired application process. Detailed examples of the process 51A are a process of executing data communication for transmitting/receiving data such as document data, image data, or an application program by controlling the communication processing unit 52, and a process of displaying, editing, or executing data obtained by data communication.

The communication processing unit 52 has a function of executing data communication via one of a plurality of connectable communication networks by controlling a communication interface for each communication network, such as the wireless LAN I/F unit 31, W-CDMA I/F unit 32, or VPN I/F unit 33 implemented by various kinds of APIs represented by, e.g., “Socket” and provided in the communication I/F unit 30. The communication processing unit 52 includes a network management unit 52A, reception unit 52R, and transmission unit 52S.

The network management unit 52A has a function of monitoring the communication I/F unit 30 and confirming, from the communication I/F unit 30, the communication network used by the process 51A for data communication, and a function of outputting a network ID unique to the communication network.

The reception unit 52R has a function, implemented by an API such as recv( ) or read( ) of, e.g., the Socket communication method, of receiving data from a communication partner apparatus on the basis of a predetermined communication protocol via a communication network connected via one of the wireless LAN I/F unit 31, W-CDMA I/F unit 32, and VPN I/F unit 33 of the communication I/F unit 30, a function of acquiring, from the network management unit 52A, a communication corresponding network ID indicating a communication network used for data communication by the process 51A, and a function of controlling transfer of reception data to the process 51A on the basis of data communication enable/disable determination of the operation determination unit 54, which is obtained in response to an operation determination request including the communication corresponding network ID.

The transmission unit 52S has a function, implemented by an API such as send( ) or write( ) of, e.g., the Socket communication method, of transmitting data to a communication partner apparatus on the basis of a predetermined communication protocol via a communication network connected via one of the wireless LAN I/F unit 31, W-CDMA I/F unit 32, and VPN I/F unit 33 of the communication I/F unit 30, a function of deriving the network name of a communication network used for data communication by the process 51A by looking up, e.g., a routing table (not shown) in the storage unit 40 on the basis of transmission destination information designated by the process 51A, a function of acquiring, from the network management unit 52A, a network ID associated with the derived network name as a communication corresponding network ID, and a function of controlling transfer of transmission data to the communication I/F unit 30 the basis of data communication enable/disable determination of the operation determination unit 54, which is obtained in response to an operation determination request including the communication corresponding network ID.

The process management unit 53 has a function of registering a set of the process ID of the process 51A and a network ID in the process management table 41, and a function of acquiring, from the process management table 41, a network ID corresponding to the process ID of the process 51A as a communication corresponding network ID.

As functions for data reception, the operation determination unit 54 has a function of acquiring, from the application processing unit 51, the process ID of the process 51A which has instructed the communication processing unit 52 to perform data reception, a function of acquiring a process corresponding network ID corresponding to the process ID from the process management unit 53, and a function of determining whether to permit data reception by the process by comparing the communication corresponding network ID with the process corresponding network ID in response to an operation determination request from the reception unit 52R, and sending an enable/disable notification to the reception unit 52R.

As functions for data transmission, the operation determination unit 54 has a function of acquiring, from the application processing unit 51, the process ID of the process 51A which has instructed the communication processing unit 52 to perform data transmission, a function of acquiring a process corresponding network ID corresponding to the process ID from the process management unit 53, and a function of determining whether to permit data transmission by the process by comparing the communication corresponding network ID with the process corresponding network ID in response to an operation determination request from the transmission unit 52S, and sending an enable/disable notification to the transmission unit 52S.

### [Operation of First Exemplary Embodiment]

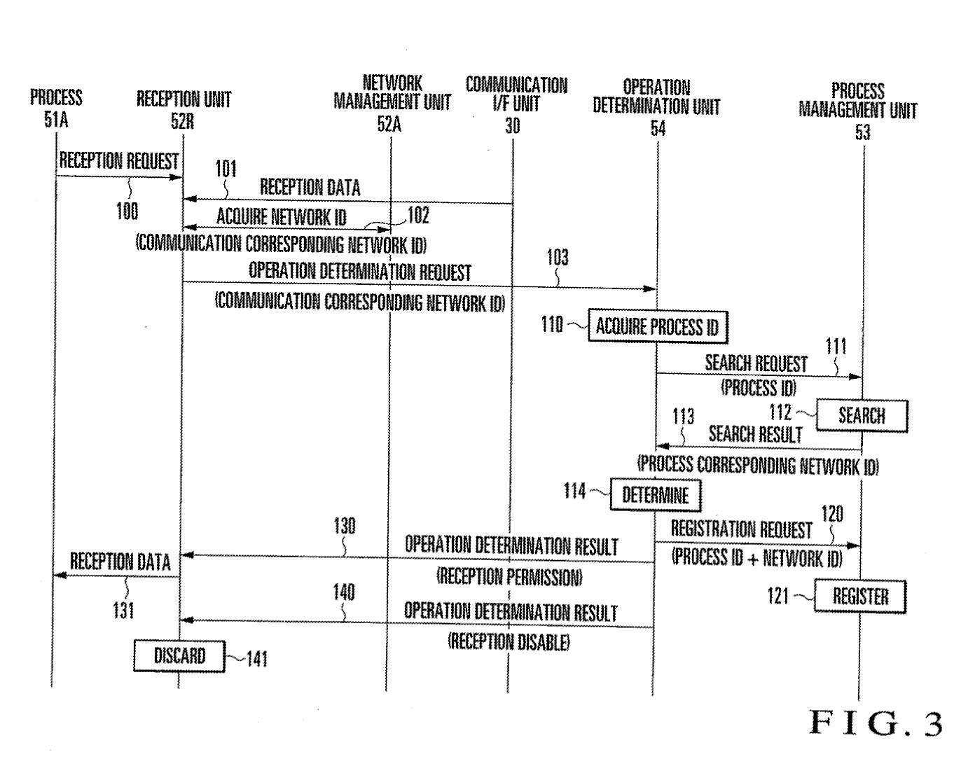

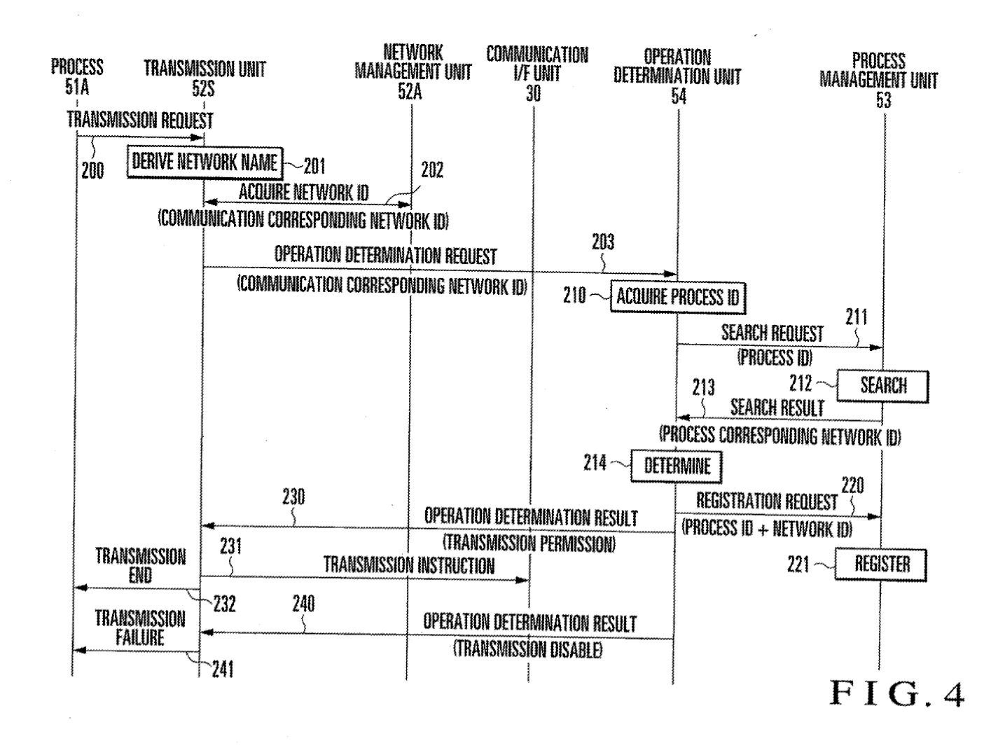

The operation of the communication apparatus according to the first exemplary embodiment of the present invention will be described next with reference to FIGS. 3 and 4. FIG. 3 shows the data reception operation of the communication apparatus according to the first exemplary embodiment of the present invention. FIG. 4 shows the data transmission operation of the communication apparatus according to the first exemplary embodiment of the present invention.

### [Data Reception Operation]

The data reception operation of the communication apparatus according to the first exemplary embodiment of the present invention will be described first with reference to FIG. 3.

When an application executed by the application processing unit 51 is going to receive data from a communication network, the arithmetic processing unit 50 of the communication apparatus 1A activates the process 51A and executes the data reception operation as shown in FIG. 3.

First, the process 51A invokes a reception API using, e.g., a buffer and length for data reception as arguments, thereby outputting a reception request to the communication processing unit 52 (step 100). In response to the request, the reception unit 52R of the communication processing unit 52 waits for data reception until reception data arrives from the communication I/F unit 30. Upon receiving data from an arbitrary communication network, the communication I/F unit 30 adds, to the reception data, the name of the reception communication interface that has received the data and outputs the reception data to the reception unit 52R (step 101).

The reception unit 52R receives the reception data and the reception communication interface name from the communication I/F unit 30 and acquires the communication corresponding network ID used for data reception from the network management unit 52A using the reception communication interface name as a key (step 102). At this time, the network management unit 52A monitors the wireless LAN I/F unit 31, W-CDMA I/F unit 32, and VPN I/F unit 33 and makes inquiries when these communication interface units have performed network connection, thereby managing the correspondence relationship between the communication networks and the interface names of these communication interface units.

After that, the reception unit 52R sends an operation determination request including the thus obtained communication corresponding network ID to the operation determination unit 54 (step 103).

In response to the operation determination request from the reception unit 52R, the operation determination unit 54 acquires, from the application processing unit 51, the process ID of the process 51A which has sent the reception request to the reception unit 52R (step 110).

Next, the operation determination unit 54 outputs, to the process management unit 53, a request to search for a network ID corresponding to the process ID (step 111).

In response to this request, the process management unit 53 looks up the process management table 41 in the storage unit 40 and executes search using the process ID designated by the search request as a key (step 112). The process management unit 53 notifies the operation determination unit 54 of the process corresponding network ID corresponding to the process ID as the search result (step 113). If the network ID is not registered, the operation determination unit 54 is notified of it.

Then, the operation determination unit 54 determines the search result from the process management unit 53 (step 114). If the search result indicates that the network ID is not registered, i.e., the operation is the first data reception by the process 51A, the operation determination unit 54 sends, to the process management unit 53, a registration instruction for the set of the process ID of the process 51A and the communication corresponding network ID (step 120). In accordance with the instruction, the process management unit 53 records the communication corresponding network ID in correspondence with the process ID in the process management table 41, thereby registering the set of the process ID and the communication corresponding network ID (step 121).

If the search result indicates that the network ID is not registered, or the process corresponding network ID indicated by the search result matches the communication corresponding network ID, the operation determination unit 54 sends an operation determination result indicating reception permission to the reception unit 52R (step 130).

Accordingly, the reception unit 52R writes the reception data received from the communication I/F unit 30 in a data reception buffer and transfers it to the process 51A (step 131). The series of data reception operations is thus ended. That is, if the operation is the first data reception by the process 51A, or if the communication network used for data reception by the process 51A in the past matches the communication network used for the current data reception, the reception data from the communication network is transferred to the process 51A.

On the other hand, if the process corresponding network ID indicated by the search result does not match the communication corresponding network ID, i.e., the communication network used for data reception by the process 51A in the past is different from the communication network used for the current data reception, the operation determination unit 54 sends, to the reception unit 52R, an operation determination result indicating that reception is disabled (step 140).

Accordingly, the reception unit 52R discards the reception data received from the communication I/F unit 30 (step 141) to inhibit the process 51A from executing data reception using the communication network corresponding to the communication corresponding network ID. The series of data reception operations is thus ended.

That is, if the communication network used for data reception by the process 51A in the past is different from the communication network used for the current data reception, the reception data from the communication network is discarded without being transferred to the process 51A. This inhibits the process 51A from executing data reception using the communication network corresponding to the communication corresponding network ID.

### [Data Transmission Operation]

The data transmission operation of the communication apparatus according to the first exemplary embodiment of the present invention will be described next with reference to FIG. 4.

When an application executed by the application processing unit 51 is going to transmit data to a communication network, the arithmetic processing unit 50 of the communication apparatus 1A activates the process 51A and executes the data transmission operation as shown in FIG. 4.

First, the process 51A invokes a transmission API using, e.g., a buffer and length for data transmission as arguments, thereby outputting a transmission request including transmission data and transmission destination information to the communication processing unit 52 (step 200).

In response to the request, the transmission unit 52S of the communication processing unit 52 derives the network name of the communication network to be used for the data transmission (step 201) and acquires, from the network management unit 52A, a network ID associated with the derived network name as a communication corresponding network ID (step 202).

After that, the transmission unit 52S sends an operation determination request including the thus obtained communication corresponding network ID to the operation determination unit 54 (step 203).

In response to the operation determination request from the transmission unit 52S, the operation determination unit 54 acquires, from the application processing unit 51, the process ID of the process 51A which has sent the transmission request to the transmission unit 52S (step 210).

Next, the operation determination unit 54 outputs, to the process management unit 53, a request to search for a network ID corresponding to the process ID (step 211).

In response to this request, the process management unit 53 looks up the process management table 41 in the storage unit 40 and executes search using the process ID designated by the search request as a key (step 212). The process management unit 53 notifies the operation determination unit 54 of the process corresponding network ID corresponding to the process ID as the search result (step 213). If the network ID is not registered, the operation determination unit 54 is notified of it.

Then, the operation determination unit 54 determines the search result from the process management unit 53 (step 214). If the search result indicates that the network ID is not registered, i.e., the operation is the first data transmission by the process 51A, the operation determination unit 54 sends, to the process management unit 53, a registration instruction for the set of the process ID of the process 51A and the communication corresponding network ID (step 220).

In accordance with the instruction, the process management unit 53 records the communication corresponding network ID in correspondence with the process ID in the process management table 41, thereby registering the set of the process ID and the communication corresponding network ID (step 221).

If the search result indicates that the network ID is not registered, or the process corresponding network ID indicated by the search result matches the communication corresponding network ID, the operation determination unit 54 sends an operation determination result indicating transmission permission to the transmission unit 52S (step 230).

Accordingly, the transmission unit 52S writes the transmission data received from the process 51A in a data transmission buffer and sends a transmission instruction to the communication I/F unit 30 (step 231). When the communication I/F unit 30 has finished transmission, the transmission unit 52S sends a transmission end notification to the process 51A (step 232). The series of data transmission operations is thus ended.

That is, if the operation is the first data transmission by the process 51A, or if the communication network used for data transmission by the process 51A in the past matches the communication network used for the current data transmission, the transmission data from the process 51A is transferred to the communication I/F unit 30 and transmitted to the corresponding communication network.

On the other hand, if the process corresponding network ID indicated by the search result does not match the communication corresponding network ID, i.e., the communication network used for data transmission by the process 51A in the past is different from the communication network used for the current data transmission, the operation determination unit 54 sends, to the transmission unit 52S, an operation determination result indicating that transmission is disabled (step 240).

Accordingly, the transmission unit 52S discards the transmission data received from the process 51A (step 241) to inhibit the process 51A from executing data transmission using the communication network corresponding to the communication corresponding network ID. The series of data transmission operations is thus ended.

That is, if the communication network used for data transmission by the process 51A in the past is different from the communication network used for the current data transmission, the transmission data from the process 51A is discarded without being transferred to the communication I/F unit 30. This inhibits the process 51A from executing data transmission using the communication network corresponding to the communication corresponding network ID.

### [Effect of First Exemplary Embodiment]

As described above, in this exemplary embodiment, when the process 51A is to execute new data communication, the operation determination unit 54 compares a communication corresponding network ID representing a communication network to be used for the data communication by the process with the process corresponding network ID of the process acquired by the process management unit 53, thereby determining whether to permit the new data communication by the process.

More specifically, if the communication corresponding network ID does not match the process corresponding network ID, the operation determination unit 54 determines that the data communication is disabled. In accordance with data communication disable determination by the operation determination unit 54, the communication processing unit 52 inhibits the process from executing the data communication using the communication network corresponding to the communication corresponding network ID.

If the communication network corresponding to the process 51A is different from the current communication network for data communication, data communication by the process 51A using the current communication network is inhibited. Only when no communication network is made to correspond to the process 51A, or the current communication network corresponds to the process 51A, data communication by the process 51A using the current communication network is permitted.

To limit accessible networks using a policy file or the like, it is necessary to grasp all accessible networks in advance and describe them in the policy file. According to this exemplary embodiment, however, no policy file is necessary because whether to permit data communication is determined based on a set of a process ID and a network ID. Neither the application creator nor the network administrator need grasp the list of connectable networks in advance. It is therefore possible to suppress any increase in work load for policy file management and ensure easy and reliable information outflow prevention in data reception.

### Second Exemplary Embodiment

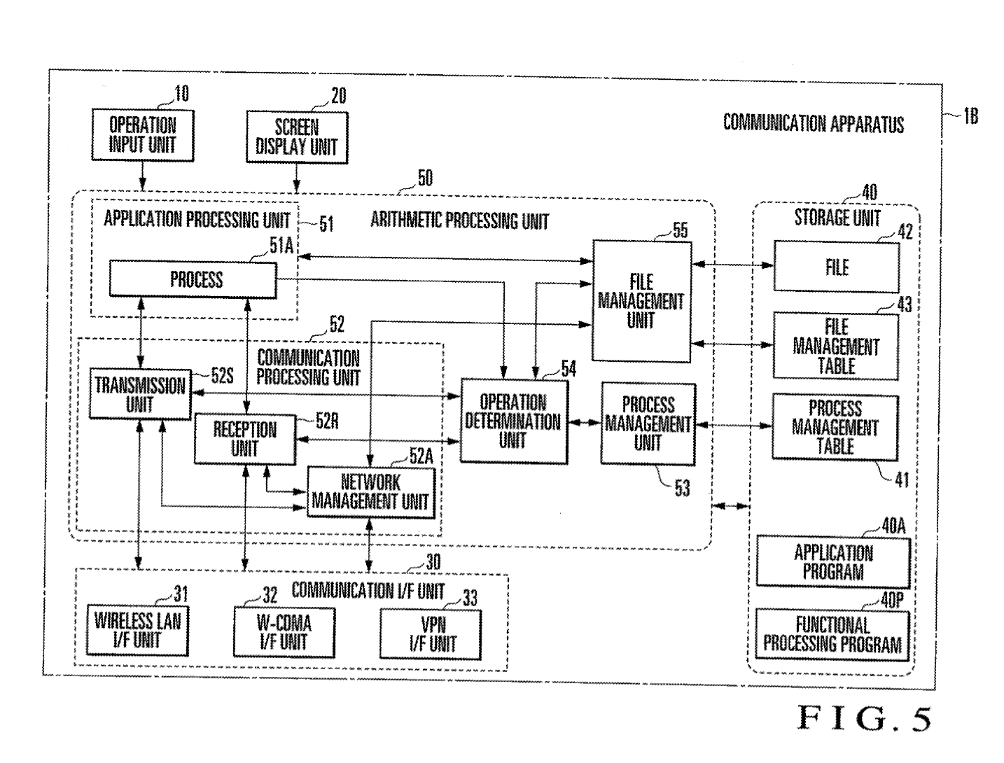

A communication apparatus according to the second exemplary embodiment of the present invention will be described next with reference to FIG. 5. FIG. 5 shows the arrangement of the communication apparatus according to the second exemplary embodiment of the present invention. The same reference numerals as in FIG. 1 described above denote the same or similar parts in FIG. 5.

In the first exemplary embodiment, information outflow prevention in data reception or data transmission by the process 51A via an arbitrary communication network has been explained. In the second exemplary embodiment, information outflow prevention in causing a process 51A to read out a file 42 stored in a storage unit 40 will be described.

A communication apparatus 1B of this exemplary embodiment has a file management unit 55 in an arithmetic processing unit 50, and the storage unit 40 stores a file management table 43 as process information, unlike the first exemplary embodiment. The remaining components are the same as in the first exemplary embodiment, and a description thereof will not be repeated.

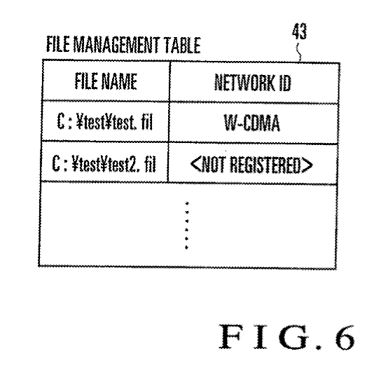

FIG. 6 shows an example of the arrangement of the file management table. The file management table 43 manages, for each file 42, a set of a file ID (file identification information) unique to a file such as a file name containing, e.g., storage location information and a file corresponding network ID unique to a communication network associated with the file.

The file management unit 55 has a function, implemented by a file write API such as write( ) fputs( ) or fprintf( ) of writing arbitrary data in the storage unit 40 as the file 42, a function of reading out the file 42 saved in the storage unit 40, a function, implemented by a file readout API such as open( ), read( ), fgets( ), or fscanf( ), of acquiring, from the file management table 43, a file corresponding network ID paired with the file ID of the file 42 in reading out the file 42 in accordance with an instruction from the process 51A, and a function of controlling transfer of file data to the process 51A on the basis of file readout enable/disable determination of an operation determination unit 54, which is obtained in response to an operation determination request including the file corresponding network ID.

The operation determination unit 54 has a function of acquiring, from an application processing unit 51, the process ID of the process 51A which has instructed the file management unit 55 to perform file readout, a function of acquiring a process corresponding network ID corresponding to the process ID from a process management unit 53, and a function of determining whether to permit file readout by the process by comparing the file corresponding network ID with the process corresponding network ID in response to an operation determination request from the file management unit 55, and sending an enable/disable notification to the file management unit 55.

### [Operation of Second Exemplary Embodiment]

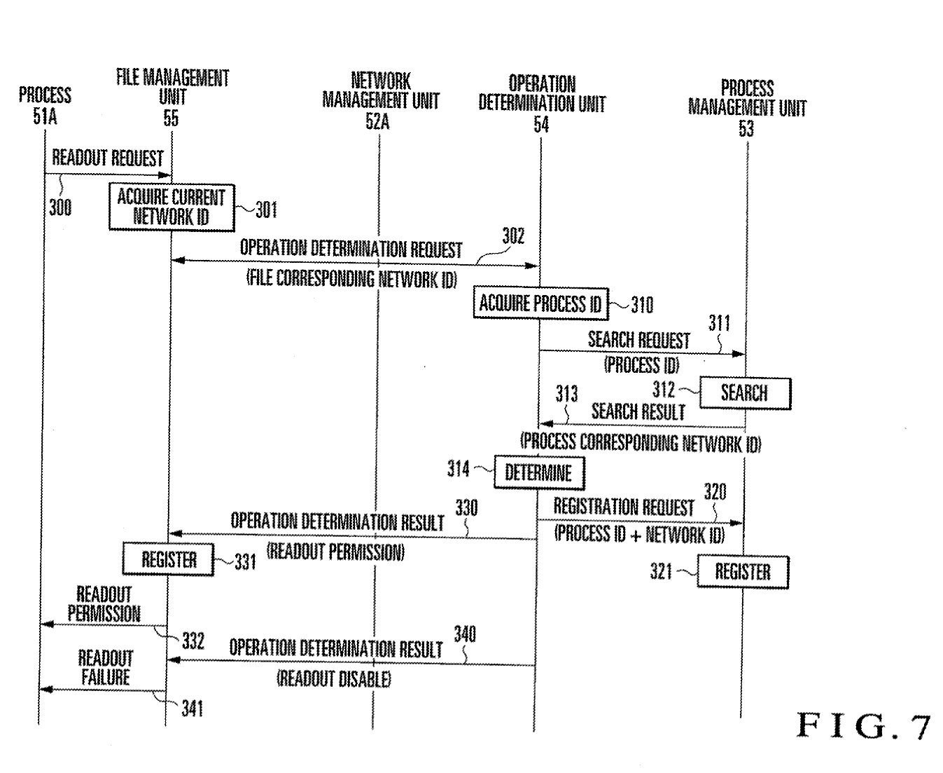

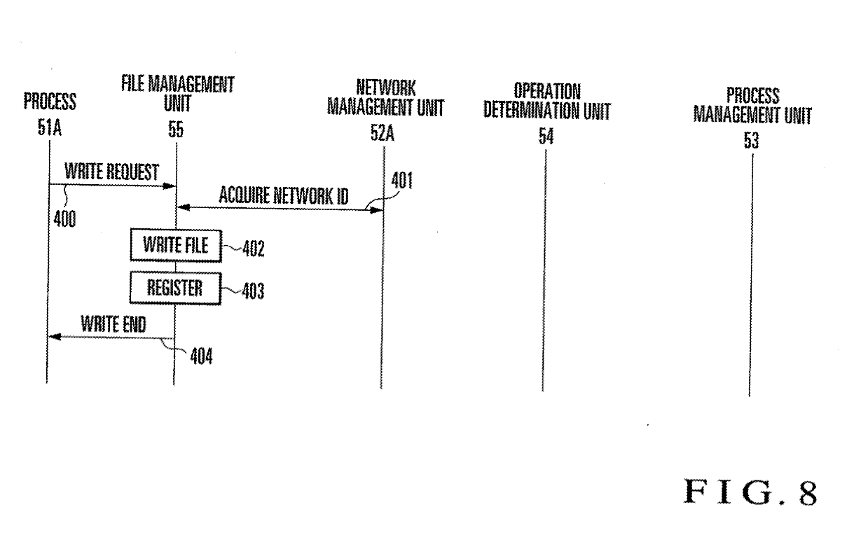

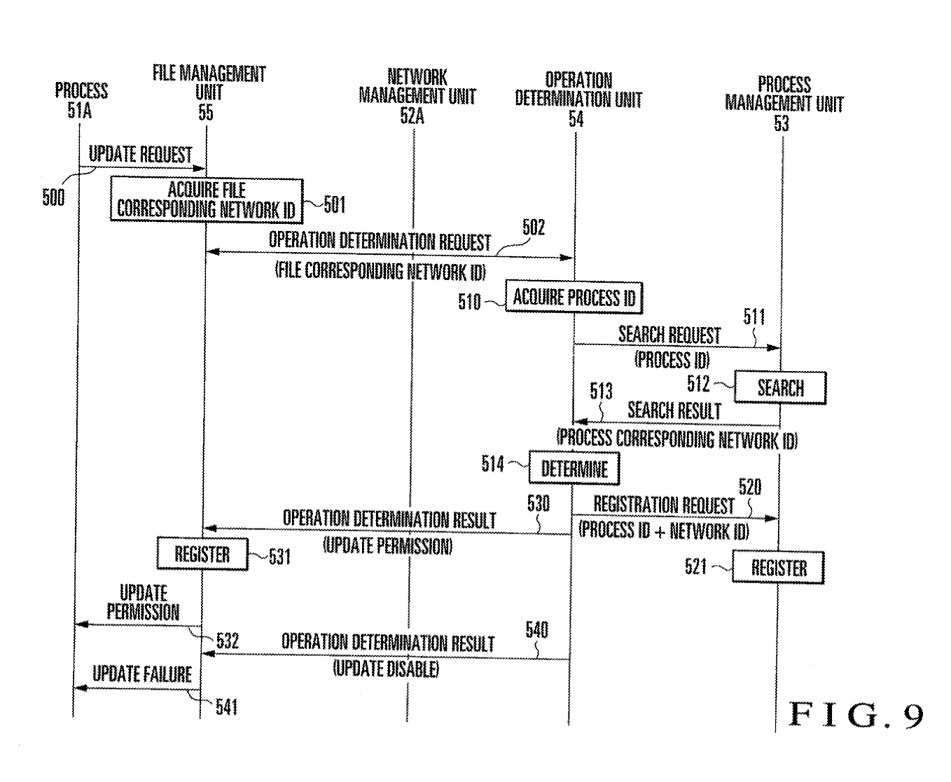

The operation of the communication apparatus according to the second exemplary embodiment of the present invention will be described next with reference to FIGS. 7 to 9. FIG. 7 shows the file readout operation of the communication apparatus according to the second exemplary embodiment of the present invention. FIG. 8 shows the file write operation of the communication apparatus according to the second exemplary embodiment of the present invention. FIG. 9 shows the file update operation of the communication apparatus according to the second exemplary embodiment of the present invention.

### [File Readout Operation]

The file readout operation of the communication apparatus according to the second exemplary embodiment of the present invention will be described first with reference to FIG. 7.

When an application executed by the application processing unit 51 is going to read out a file from the storage unit 40, the arithmetic processing unit 50 of the communication apparatus 1B activates the process 51A and executes the file readout operation as shown in FIG. 7.

First, the process 51A invokes a file readout API, thereby outputting, to the file management unit 55, a readout request containing a file name with the storage location information of the file 42 as the readout target (step 300).

In response to the request, the file management unit 55 acquires, from the file management table 43 in the storage unit 40, a file corresponding network ID made to correspond to the file 42 in advance (step 301). If the network ID is not registered, the file corresponding network ID is defined as unregistered.

After that, the file management unit 55 sends an operation determination request including the thus obtained file corresponding network ID to the operation determination unit 54 (step 302).

In response to the operation determination request from the file management unit 55, the operation determination unit 54 acquires, from the application processing unit 51, the process ID of the process 51A which has sent the readout request to the file management unit 55 (step 310).

Next, the operation determination unit 54 outputs, to the process management unit 53, a request to search for a network ID corresponding to the process ID (step 311).

In response to this request, the process management unit 53 looks up a process management table 41 in the storage unit 40 and executes search using the process ID designated by the search request as a key (step 312). The process management unit 53 notifies the operation determination unit 54 of the process corresponding network ID corresponding to the process ID as the search result (step 313). If the network ID is not registered, the operation determination unit 54 is notified of it.

Then, the operation determination unit 54 determines the search result from the process management unit 53 (step 314). If the search result indicates that the network ID is not registered, i.e., the operation is the first data readout by the process 51A, the operation determination unit 54 sends, to the process management unit 53, a registration instruction for the set of the process ID of the process 51A and the file corresponding network ID (step 320).

In accordance with the instruction, the process management unit 53 records the file corresponding network ID in correspondence with the process ID in the process management table 41, thereby registering the set of the process ID and the file corresponding network ID (step 321). Accordingly, the communication network to be used for data communication by the process 51A is limited to the communication network corresponding to the readout target file. That is, the process 51A is contaminated with the readout target file.

If the process corresponding network ID indicated by the search result matches the file corresponding network ID, or one of the process corresponding network ID and file corresponding network ID is not registered, the operation determination unit 54 sends an operation determination result indicating readout permission to the file management unit 55 (step 330).

If one of the process corresponding network ID and the file corresponding network ID is not registered, the file management unit 55 registers the correspondence relationship between the file ID and the network ID in the file management table 43 (step 331). Upon receiving the readout permission notification, the file management unit 55 notifies the process 51A that readout of the file 42 is permitted (step 332). The series of data readout operations is thus ended.

That is, if no network ID is made to correspond to the file 42, or the process 51A has not executed data communication yet, readout of the file 42 is permitted.

On the other hand, if the process corresponding network ID does not match the file corresponding network ID, and both the process corresponding network ID and the file corresponding network ID are registered, the operation determination unit 54 sends, to the file management unit 55, an operation determination result indicating that readout is disabled (step 340).

Accordingly, the file management unit 55 notifies the process 51A of the file readout failure without reading out the file 42 from the storage unit 40 (step 341). The series of data readout operations is thus ended.

That is, if network IDs are made to correspond to both of the file 42 and the process 51A, and the two network IDs are different, readout of the file 42 is inhibited.

### [File Write Operation]

The file write operation of the communication apparatus according to the second exemplary embodiment of the present invention will be described next with reference to FIG. 8.

When an application executed by the application processing unit 51 is going to write a file in the storage unit 40, the arithmetic processing unit 50 of the communication apparatus 1B activates the process 51A and executes the file write operation as shown in FIG. 8.

First, the process 51A invokes a file write API or file open API using, e.g., a file name with the storage location information of the file 42 as the write target, and also a buffer and length as arguments, thereby outputting a write request to the file management unit 55 (step 400).

In response to the request, the file management unit 55 acquires, from a network management unit 52A, a communication corresponding network ID indicating a communication network that is currently being connected for data communication by the process 51A (step 401).

Next, the file management unit 55 creates, in the storage unit 40, the file 42 having the file name with the storage location information designated by the process 51A, reads out data corresponding to the designated length from the buffer, and writes it in the file (step 402). If the API invoked by the process 51A is a write file open API, the file management unit 55 can open only the file (for preparation for write) in step 402.

After that, the file management unit 55 registers the communication corresponding network ID acquired from the network management unit 52A in the file management table 43 of the storage unit 40 as a file corresponding network ID (step 403) and sends a file write end notification or a write permission notification to the process 51A (step 404). The series of data write operations is thus ended.

### [File Update Operation]

The file update operation of the communication apparatus according to the second exemplary embodiment of the present invention will be described next with reference to FIG. 9.

When an application executed by the application processing unit 51 is going to update a file in the storage unit 40, the arithmetic processing unit 50 of the communication apparatus 1B activates the process 51A and executes the file update operation as shown in FIG. 9.

First, to execute file update such as rewrite or additional write of the file 42, the process 51A invokes a file update API using, e.g., a file name with the storage location information of the file 42 as the update target, and also a buffer and length as arguments, thereby outputting an update request to the file management unit 55 (step 500).

In response to the request, the file management unit 55 acquires a file corresponding network ID corresponding to the file 42 from the file management table 43 in the storage unit 40 (step 501) and outputs an operation determination request including the file corresponding network ID to the operation determination unit 54 (step 502).

In response to the operation determination request from the file management unit 55, the operation determination unit 54 acquires, from the application processing unit 51, the process ID of the process 51A which has sent the update request to the file management unit 55 (step 510).

Next, the operation determination unit 54 outputs, to the process management unit 53, a request to search for a process corresponding network ID corresponding to the process ID (step 511).

In response to this request, the process management unit 53 looks up the process management table 41 in the storage unit 40 and executes search using the process ID designated by the search request as a key (step 512). The process management unit 53 notifies the operation determination unit 54 of the process corresponding network ID corresponding to the process ID as the search result (step 513). If the network ID is not registered, the operation determination unit 54 is notified of it.

Then, the operation determination unit 54 determines the search result from the process management unit 53 (step 514). If the search result indicates that the network ID is not registered, i.e., the operation is the first data update by the process 51A, the operation determination unit 54 sends, to the process management unit 53, a registration instruction for the set of the process ID of the process 51A and the file corresponding network ID (step 520).

In accordance with the instruction, the process management unit 53 records the file corresponding network ID in correspondence with the process ID in the process management table 41, thereby registering the set of the process ID and the communication corresponding network ID (step 521). Accordingly, the communication network to be used for data communication by the process 51A is limited to the communication network corresponding to the update target file. That is, the process 51A is contaminated with the update target file.

If the process corresponding network ID indicated by the search result matches the file corresponding network ID, or one of the process corresponding network ID and file corresponding network ID is not registered, the operation determination unit 54 sends an operation determination result indicating update permission to the file management unit 55 (step 530).

If one of the process corresponding network ID and the file corresponding network ID is not registered, the file management unit 55 registers the correspondence relationship between the file ID and the network ID in the file management table 43 (step 531). Upon receiving the update permission notification, the file management unit 55 notifies the process 51A that update of the file 42 is permitted (step 532). The series of data update operations is thus ended.

That is, if no network ID is made to correspond to the file 42, or the process 51A has not executed data communication yet, update of the file 42 is permitted.

On the other hand, if the process corresponding network ID does not match the file corresponding network ID, and both the process corresponding network ID and the file corresponding network ID are registered, the operation determination unit 54 sends, to the file management unit 55, an operation determination result indicating that update is disabled (step 540).

Accordingly, the file management unit 55 notifies the process 51A of the file update failure without updating the file 42 in the storage unit 40 (step 541). The series of data update operations is thus ended.

That is, if network IDs are made to correspond to both of the file 42 and the process 51A, and the two network IDs are different, update of the file 42 is inhibited.

### [Effect of Second Exemplary Embodiment]

As described above, in this exemplary embodiment, when the file management unit 55 is to read out the file 42, the operation determination unit 54 compares a file corresponding network ID corresponding to the file 42 with the process corresponding network ID of the process 51A acquired by the process management unit 53, thereby determining whether to permit file readout by the process 51A.

In writing the file 42 in response to a request from the process 51A, the file management unit 55 registers a communication corresponding network ID representing a communication network to be used by the process 51A, which is acquired from the network management unit 52A, in the file management table 43 in correspondence with the file ID of the file 42.

When the file management unit 55 is to update the file 42 in response to a request from the process 51A, the operation determination unit 54 compares a file corresponding network ID corresponding to the file 42 with the process corresponding network ID of the process 51A acquired by the process management unit 53, thereby determining whether to permit file update by the process 51A.

If the communication network corresponding to the process 51A is different from the communication network used for readout, write, or update of the file 42, the readout, write, or update of the file 42 can be inhibited.

It is therefore possible to strictly inhibit data generated at the time of network access from being transferred to another network due to, e.g., a bug in an application.

### [Extension of Exemplary Embodiment]

In the above exemplary embodiments, an example has been described, in which both data reception and data transmission are performed by providing the reception unit 52R and the transmission unit 52S in the communication processing unit 52. However, the present invention is not limited to this.

For example, the communication processing unit 52 may include at least the reception unit 52R. The operation determination unit 54 may compare a communication corresponding network ID representing a communication network to be used for data communication of a process with a process corresponding network ID acquired by the process management unit 53, thereby determining only whether to permit data reception.

Alternatively, the communication processing unit 52 may include at least the transmission unit 52S. The operation determination unit 54 may compare a communication corresponding network ID representing a communication network to be used for data transmission of a process with a process corresponding network ID acquired by the process management unit 53, thereby determining only whether to permit data transmission.

The second exemplary embodiment has been described based on the arrangement of the first exemplary embodiment. However, the present invention is not limited to this. It is also possible to apply the second exemplary embodiment to a communication apparatus which does not have the characteristic portions of the first exemplary embodiment, i.e., the arrangement for causing the operation determination unit 54 to determine whether to permit data communication, as described above, and obtain the same functions and effects as described above.

In the exemplary embodiments, an example has been described in which after activation of a process, a network ID unique to a communication network used by the process for the first data communication is registered in the process management table in correspondence with the process ID of the process. However, the present invention is not limited to this. A usable communication network may be registered in advance in the process management table in correspondence with each application or the contents of each process. This allows to limit the usable communication network for each application or the contents of each process.

In the exemplary embodiments, an example has been described in which the operation determination unit 54 and the process management unit 53 are implemented as processing units separated for the communication processing unit 52 and the file management unit 55. However, the present invention is not limited to this. The operation determination unit 54 or the process management unit 53 may be implemented as one processing unit in the communication processing unit 52 or the file management unit 55, as needed.

In the exemplary embodiments, an example has been described in which the process management unit 53 manages the process management table 41, and the file management unit 55 manages the file management table 43. However, the present invention is not limited to this. One management unit, and for example, an identification information management unit may collectively manage the process management table 41 and the file management table 43.

In the second exemplary embodiment, an example has been described in which the storage unit 40 stores the file 42 and the file management table 43 together with other pieces of process information. However, the present invention is not limited to this. It is also possible to apply the second exemplary embodiment to an arrangement for storing the file 42 and the file management table 43 in a storage formed from a storage device different from the storage unit 40, as described above, and obtain the same functions and effects as described above.

### INDUSTRIAL APPLICABILITY

The exemplary embodiment of the present invention is usable for an information outflow prevention technique in various kinds of communication apparatuses such as a portable terminal, PDA, and personal computer each of which executes data communication using a communication network.

1-15. (canceled)

16. A communication apparatus characterized by comprising:
a communication processing unit which executes data communication via one of a plurality of connectable communication networks;
an application processing unit which executes a desired application in process by controlling said communication processing unit and activating a process of executing data communication for at least one of data reception and data transmission;
a storage unit which stores a process management table to register a set of process identification information unique to the process and network identification information unique to a communication network made to correspond to the process in advance;
a process management unit which acquires network identification information corresponding to the process identification information of the process from the process management table; and
an operation determination unit which, in performing new data communication by the process, compares communication corresponding network identification information representing a communication network to be used for data communication by the process with process corresponding network identification information which is the network identification information of the process acquired by said process management unit, thereby determining whether to permit the new data communication by the process, wherein
said storage unit stores a file that describes arbitrary data, and a file management table to register a set of file identification information unique to the file and network identification information unique to a communication network made to correspond to the file,
said apparatus further comprises a file management unit which, on the basis of an instruction from the process, executes file access to said storage unit to at least read out or write the file, and acquires, from the file management table, network identification information corresponding to the file identification information of the file to be file-accessed by the process, and
when the process is to execute new file access to said storage unit, said operation determination unit determines whether to permit the new file access by the process in accordance with a result of comparison between the process corresponding network identification information corresponding to the process and file corresponding network identification information which is network identification information of the file acquired by said file management unit.

17. An apparatus according to claim 16, characterized in that
when the process corresponding network identification information does not match the file corresponding network identification information, said operation determination unit determines that file access is disabled, and
said file management unit inhibits the process from executing the new file access in accordance with file access disable determination by said operation determination unit.

18. An apparatus according to claim 16, characterized in that when the process is to execute new file access for an arbitrary file, said file management unit registers, in the file management table, a set of file identification information unique to the file and network identification information representing a communication network to be used for data communication by the process.

19. A communication apparatus characterized by comprising:
a communication processing unit which executes data communication via one of a plurality of connectable communication networks;
an application processing unit which executes a desired application process by controlling said communication processing unit and activating a process of executing data communication for at least one of data reception and data transmission;
a storage unit which stores a file that describes arbitrary data, and a file management table to register a set of file identification information unique to the file and network identification information unique to a communication network made to correspond to the file;
a file management unit which, on the basis of an instruction from the process, executes file access to said storage unit to at least read out or write the file, and acquires, from the file management table, network identification information corresponding to the file identification information of the file to be file-accessed by the process; and
an operation determination unit which determines, when the process is to execute new file access to said storage unit, whether to permit the new file access by the process in accordance with a result of comparison between process corresponding network identification information which is network identification information representing a communication network to be used for data communication by the process and file corresponding network identification information which is network identification information of the file acquired by said file management unit.

20. A communication control method of a communication apparatus which includes an arithmetic processing unit and a storage unit and executes data communication via one of a plurality of connectable communication networks, characterized by comprising:
the communication processing step of causing the arithmetic processing unit to execute data communication via one of a plurality of connectable communication networks;
the application processing step of causing the arithmetic processing unit to execute a desired application process by controlling the communication processing step and activating a process of executing data communication for at least one of data reception and data transmission;
the storage step of causing the storage unit to store a process management table to register a set of process identification information unique to the process and network identification information unique to a communication network made to correspond to the process in advance;
the process management step of causing the arithmetic processing unit to acquire network identification information corresponding to the process identification information of the process from the process management table; and
the operation determination step of, in performing new data communication by the process, causing the arithmetic processing unit to compare communication corresponding network identification information representing a communication network to be used for data communication by the process with process corresponding network identification information which is the network identification information of the process acquired in the process management step, thereby determining whether to permit the new data communication by the process, wherein
the storage unit stores a file that describes arbitrary data, and a file management table to register a set of file identification information unique to the file and network identification information unique to a communication network made to correspond to the file,
the method further comprises the file management step of, on the basis of an instruction from the process, executing file access to the storage unit to at least read out or write the file, and acquiring, from the file management table, network identification information corresponding to the file identification information of the file to be file-accessed by the process, and
in the operation determination step, when the process is to execute new file access to the storage unit, it is determined whether to permit the new file access by the process in accordance with a result of comparison between the process corresponding network identification information corresponding to the process and file corresponding network identification information which is network identification information of the file acquired in the file management step.

21. A method according to claim 20, characterized in that
in the operation determination step, when the process corresponding network identification information does not match the file corresponding network identification information, it is determined that file access is disabled, and
in the file management step, the process is inhibited from executing the new file access in accordance with file access disable determination in the operation determination step.

22. A method according to claim 20, characterized in that in the file management step, when the process is to execute new file access for an arbitrary file, a set of file identification information unique to the file and network identification information representing a communication network to be used for data communication by the process is registered in the file management table.

23. A communication control method of a communication apparatus which includes an arithmetic processing unit and a storage unit and executes data communication via one of a plurality of connectable communication networks, characterized by comprising:
is the communication processing step of causing the arithmetic processing unit to execute data communication via one of a plurality of connectable communication networks;
the application processing step of causing the arithmetic processing unit to execute a desired application process by controlling the communication processing step and activating a process of executing data communication for at least one of data reception and data transmission;
the storage step of causing the storage unit to store a file that describes arbitrary data, and a file management table to register a set of file identification information unique to the file and network identification information unique to a communication network made to correspond to the file,
the file management step of causing the arithmetic processing unit to execute, on the basis of an instruction from the process, file access to the storage unit to at least read out or write the file, and acquire, from the file management table, network identification information corresponding to the file identification information of the file to be file-accessed by the process, and
the operation determination step of, when the process is to execute new file access to the storage unit, determining whether to permit the new file access by the process in accordance with a result of comparison between the process corresponding network identification information corresponding to the process and file corresponding network identification information which is network identification information of the file acquired in the file management step.

24. A program for causing a computer of a communication apparatus which includes an arithmetic processing unit and a storage unit and executes data communication via one of a plurality of connectable communication networks to execute
the communication processing step of causing the arithmetic processing unit to execute data communication via one of a plurality of connectable communication networks;
the application processing step of causing the arithmetic processing unit to execute a desired application process by controlling the communication processing step and activating a process of executing data communication for at least one of data reception and data transmission;
the first storage step of causing the storage unit to store a process management table to register a set of process identification information unique to the process and network identification information unique to a communication network made to correspond to the process in advance;
the process management step of causing the arithmetic processing unit to acquire network identification information corresponding to the process identification information of the process from the process management table;
the first operation determination step of, in performing new data communication by the process, causing the arithmetic processing unit to compare communication corresponding network identification information representing a communication network to be used for data communication by the process with process corresponding network identification information which is the network identification information of the process acquired in the process management step, thereby determining whether to permit the new data communication by the process;
the second storage step of causing the storage unit to store a file that describes arbitrary data, and a file management table to register a set of file identification information unique to the file and network identification information unique to a communication network made to correspond to the file;
the file management step of, on the basis of an instruction from the process, executing file access to the storage unit to at least read out or write the file, and acquiring, from the file management table, network identification information corresponding to the file identification information of the file to be file-accessed by the process; and
the second operation determination step of, in performing new file access to the storage unit by the process, determining whether to permit the new file access by the process in accordance with a result of comparison between the process corresponding network identification information corresponding to the process and file corresponding network identification information which is network identification information of the file acquired in the file management step.
